(19) United States
(12) Patent Application Publication
(10) Pub. No.: US 2006/0004935 A1
(43) Pub. Date: Jan. 5, 2006

(54) Multi-protocol bridge

(76) Inventors: Pak-Lung Seto, Shrewsbury, MA (US); Jeffrey D. Skirvin, Mesa, AZ (US)

Correspondence Address: Grossman, Tucker, Perreault & Pfleger, PLLC;c/o PortfolioIP, P.O. Box 52050, Minneapolis, MN, 55402, US

(21) Appl. No.: 10/881,657

(22) Filed: Jun. 30, 2004

(51) Int. Cl. G06F 13/10

(52) U.S. Cl. 710/62

(57) ABSTRACT

A method according to one embodiment may include receiving a first portion of data compliant with a first communication protocol via a first communication link, converting the first portion of data into a second portion of data compliant with a second communication protocol for communication on a second communication link, receiving a third portion of data the compliant with the first communication protocol via the first communication link, and converting the third portion of data into a fourth portion of data compliant with a third communication protocol for communication on a third communication link. Of course, many alternatives, variations, and modifications are possible without departing from this embodiment.

### FIELD

This disclosure relates to a multi-protocol bridge.

### BACKGROUND

A conventional data storage system may include one device capable of bidirectional communication with another device. One device may include a computer node having a host bus adapter (HBA). The other device may be a mass storage device. The HBA and mass storage device may each function as a transmitting and receiving device in order to exchange data and/or commands with each other using one or more of a variety of communication protocols. Typically, each HBA and the mass storage device are capable of communicating using only a single communication protocol. Therefore, if the HBA and the mass storage device are compatible with separate protocols, a bridge may be used to convert information from one protocol to the next protocol to permit communication there between. However, in one prior art embodiment, such a bridge is limited to converting data compliant with one protocol to data compliant with a second protocol. Hence, such a bridge is not able to accommodate multiple protocol conversions.

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a diagram illustrating a system embodiment;

FIG. 2 is a diagram illustrating in greater detail a device in the system embodiment of FIG. 1;

FIG. 3 is a diagram illustrating in greater detail an embodiment of the multi-protocol bridge of the system of FIG. 1; and

FIG. 4 is a flow chart illustrating operations according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

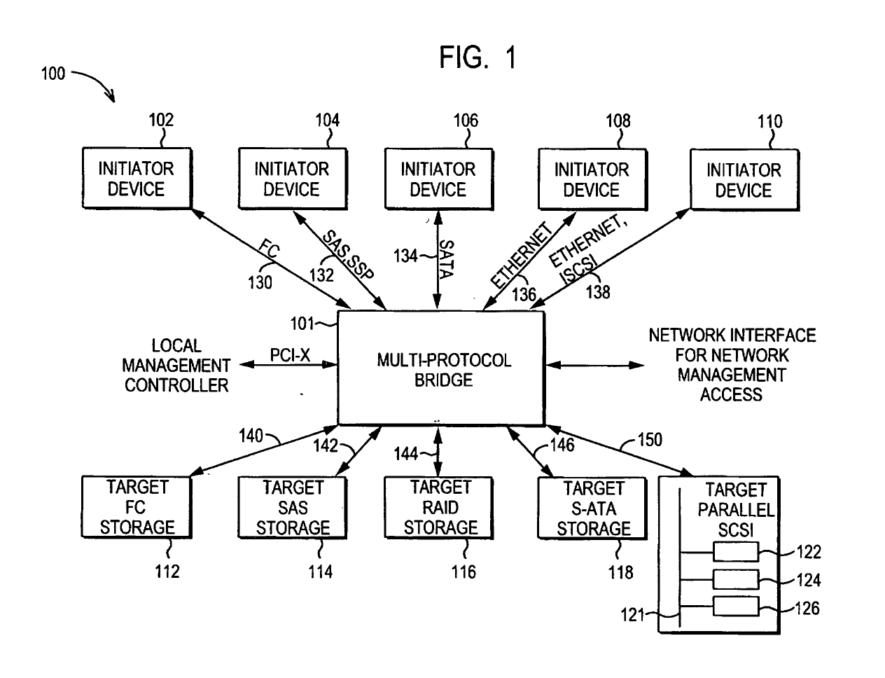

FIG. 1 illustrates a data storage system 100 including a multi-protocol bridge 101 consistent with an embodiment. The multi-protocol bridge 101 may have a plurality of ports for coupling to a plurality of initiator devices 102, 104, 106, 108, 110 via an associated plurality of communication links 130, 132, 134, 136, 138 for bidirectional communication of data and/or commands there between. The multi-protocol bridge 101 may also have a plurality of ports for coupling to a plurality of target devices 112, 114, 116, 118, 122, 124, 126 via an associated plurality of communication links 140, 142, 144, 146, 150 for bidirectional communication of data and/or commands there between.

One or more of initiator devices 102, 104, 106, 108, 110 may be various computer servers having a respective HBA as further described herein. One or more of the target devices 112, 114, 116, 118, 122, 124, 126 may comprise mass storage. The initiator devices and target devices may act as both transmitting and receiving devices to transmit data and/or commands to each other. In some instances, such data and/or commands may be included in frames. A “frame” as used herein may comprise one or more symbols and values. A large number of frames from many different target and initiator devices may be transmitted and received.

Advantageously, a variety of initiator and target devices capable of communicating utilizing a variety of communication protocols may be coupled to the multi-protocol bridge 101. Such communication protocols may include, but are not limited to, Fibre Channel (FC), Serial Advanced Technology Attachment (S-ATA), Serial Attached Small Computer Systems Interface (SAS) protocol, Ethernet, asynchronous transfer mode (ATM), and/or Parallel Small Computer System Interface (SCSI) (Parallel SCSI).

The FC protocol may comply or be compatible with the interface/protocol described in ANSI Standard Fibre Channel (FC) Physical and Signaling Interface-3 X3.303:1998 Specification. The S-ATA protocol may comply or be compatible with the protocol described in “Serial ATA: High Speed Serialized AT Attachment,” Revision 1.0, published on Aug. 29, 2001 by the Serial ATA Working Group. The SAS protocol may comply or be compatible with the protocol described in “Information Technology—Serial Attached SCSI—1.1 (SAS),” Working Draft American National Standard of International Committee For Information Technology Standards (INCITS) T10 Technical Committee, Project T10/1562-D, Revision 1, published Sep. 18, 2003, by American National Standards Institute (hereinafter termed the “SAS Standard”) and/or later-published versions of the SAS Standard.

The ATM protocol may comply or be compatible with the plurality of ATM Standards approved by the ATM Forum including, for example, “ATM User-Network Interface (UNI) Signaling Specification” published April 2002 by the ATM Forum. The Ethernet protocol may comply or be compatible with the Ethernet standard published by the Institute of Electrical and Electronics Engineers (IEEE) titled the IEEE 802.3 standard, published in March, 2002 and/or later versions of this standard. Finally, the Parallel SCSI protocol may comply or be compatible with the interface/protocol described in “Information technology—SCSI Parallel Interface-5 (SPI-5)” Working Draft American National Standard of International Committee For Information Technology Standards (INCITS) T10 Technical Committee, Project T10/1525-D, Revision 6, published Sep. 18, 2003, by American National Standards Institute (hereinafter termed the “Parallel SCSI Standard”) and/or later-published versions of the Parallel SCSI Standard.

Again, a variety of initiator and target devices capable of communicating utilizing a variety of communication protocols may be coupled to the multi-protocol bridge 101. For communication between the initiator devices and the multi-protocol bridge, communication via communication links 130, 132, 134, 136, 138 may comply with a variety of communication protocols such as FC, SAS, S-ATA, and Ethernet. For example, communication between the initiator device 102 and the multi-protocol bridge 101 via communication link 130 may comply or be compatible with the FC protocol, communication between the initiator device 104 and the multi-protocol bridge 101 via communication link 132 may comply or be compatible with the SAS protocol. In addition, communication between the initiator device 108 and the multi-protocol bridge 101 via communication link 136 may comply or be compatible with the Ethernet protocol.

The target devices may also include a plurality of different devices capable of communicating with the multi-protocol bridge 101 using different communication protocols. For instance, target device 112 may include a FC storage device. Device 114 may include a SAS storage device. Device 116 may include one or more redundant arrays of independent disks (RAID). Device 118 may include a S-ATA storage device. A plurality of Parallel SCSI devices 122, 124, 126 may be coupled to a parallel bus 121. Communications via respective communication links 140, 142, 144, 146, 150 to the target devices 112, 114, 116, 118, 122, 124, 126 may comply with a variety of communication protocols such as FC, SAS, S-ATA, Ethernet and/or Parallel SCSI as appropriate to provide for bidirectional communication between the target devices and the multi-protocol bridge 101. For instance, communication between the multi-protocol bridge 101 and target device 112 via communication link 140 may comply or be compatible with the FC protocol, while communication between the multi-protocol bridge 101 and target device 114 via communication link 142 may comply or be compatible with the SAS protocol.

The multi-protocol bridge 101 may accept information compatible with any plurality of communication protocols and, as necessary, convert such information into information compatible with another communication protocol to facilitate bidirectional communication between devices that may communicate using different communication protocols. For example, initiator device 102 and target device 114 may be able to exchange data and/or commands via the multi-protocol bridge 101 since the multi-protocol bridge may convert information compatible with the FC protocol to the SAS protocol and vice versa. In addition, the initiator device 102 and target device 118 may also be able to exchange data and/or commands via the multi-protocol bridge 101 since the multi-protocol bridge may convert information compatible with the FC protocol to the S-ATA protocol and vice versa. Similarly, the multi-protocol bridge 101 may make other protocol conversions to enable permit communication between any combination of the initiator devices 102, 104, 106, 108, 110 and the target devices 112, 114, 116, 118, 122, 124, 126.

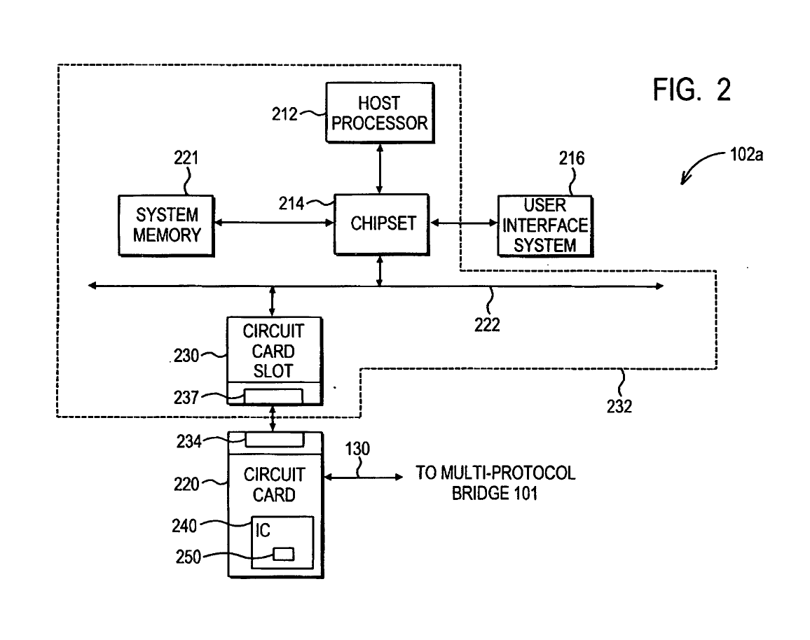

FIG. 2 illustrates an embodiment 102a of the initiator device 102 of the system of FIG. 1. The initiator device 102a may include a computer node having a HBA, e.g., circuit card 220. The circuit card 220 may be capable of bidirectional communication with any of the target devices 112, 114, 116, 118, 122, 124, 126 via the multi-protocol bridge 101. The HBA 220 may act as a transmitting and receiving device that transmits and receives data and/or commands from other target devices via the multi-protocol bridge 101. The HBA 220 may have protocol engine circuitry 250 to facilitate such communication. The protocol engine circuitry 250 may exchange data and commands with other devices by transmission and reception of one or more frames. The protocol engine circuitry 250 may be included in an integrated circuit (IC) 240. As used herein, an “integrated circuit” or IC means a semiconductor device and/or microelectronic device, such as, for example, a semiconductor integrated circuit chip. Also as used herein, “circuitry” may comprise, for example, singly or in any combination, hardwired circuitry, programmable circuitry, state machine circuitry, and/or firmware that stores instructions executed by programmable circuitry.

Some target devices may also have such protocol engine circuitry. The device 102a may include a host processor 212, a bus 222, a user interface system 216, a chipset 214, system memory 221, a circuit card slot 230, and a circuit card 220. The host processor 212 may include one or more processors known in the art such as an Intel® Pentium® IV processor commercially available from the Assignee of the subject application. The bus 222 may include various bus types to transfer data and commands. For instance, the bus 222 may comply with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). The bus 222 may alternatively comply with the PCI-X Specification Rev. 1.0a, Jul. 24, 2000, available from the aforesaid PCI Special interest Group, Portland, Oreg., U.S.A. (hereinafter referred to as a “PCI-X bus”).

The user interface system 216 may include one or more devices for a human user to input commands and/or data and/or to monitor the system, such as, for example, a keyboard, pointing device, and/or video display. The chipset 214 may include a host bridge/hub system (not shown) that couples the processor 212, system memory 221, and user interface system 216 to each other and to the bus 222. Chipset 214 may include one or more integrated circuit chips, such as those selected from integrated circuit chipsets commercially available from the assignee of the subject application (e.g., graphics memory and I/O controller hub chipsets), although other integrated circuit chips may also, or alternatively be used. The processor 212, system memory 221, chipset 214, bus 222, and circuit card slot 230 may be on one circuit board 232 such as a system motherboard.

The circuit card 220 may be constructed to permit it to be inserted into the circuit card slot 230. When the circuit card 220 is properly inserted into the slot 230, connectors 234 and 237 become electrically and mechanically coupled to each other. When connectors 234 and 237 are so coupled to each other, the card 220 becomes electrically coupled to bus 222 and may exchange data and/or commands with system memory 221, host processor 212, and/or user interface system 216 via bus 222 and chipset 214.

Alternatively, without departing from this embodiment, the operative circuitry of the circuit card 220 may be included in other structures, systems, and/or devices. These other structures, systems, and/or devices may be, for example, in the motherboard 232, and coupled to the bus 222. These other structures, systems, and/or devices may also be, for example, comprised in chipset 214.

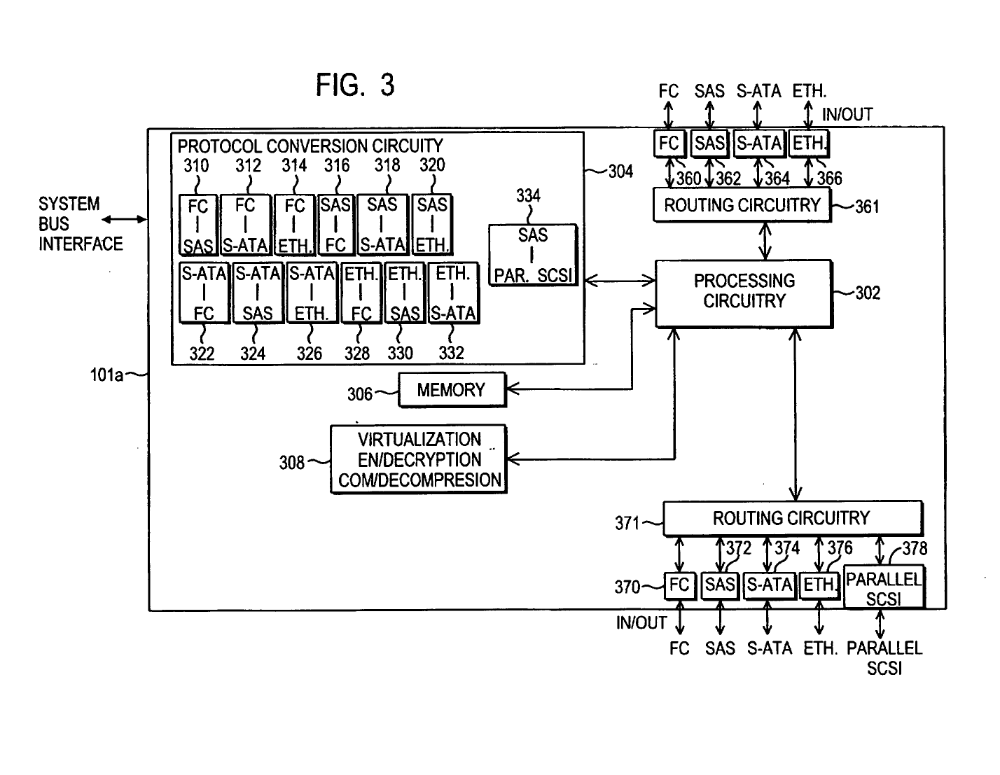

FIG. 3 illustrates an embodiment 101a of the multi-protocol bridge 101 of the system of FIG. 1. The multi-protocol bridge 101a may include memory 306, processing circuitry 302, protocol conversion circuitry 304, and a plurality of ports 360, 362, 364, 366, 370, 372, 374, 376, 378. Other value added features 308 may also be added the multi-protocol bridge 101a in some embodiments.

Memory 306 may include one or more machine readable storage media such as random-access memory (RAM), dynamic RAM (DRAM), static RAM (SRAM) magnetic disk (e.g. floppy disk and hard drive) memory, optical disk (e.g. CD-ROM) memory, and/or any other device that can store information. Although memory 306 is illustrated in the embodiment 101a as being internal to the bridge 101a, the memory 306 may also be located external to the bridge and accessible as necessary by the processing circuitry 302 of the bridge. Processing circuitry 302 may include processor core circuitry that may comprise a plurality of processor cores. As used herein, a “processor core” may comprise hardwired circuitry, programmable circuitry, and/or state machine circuitry. A plurality of ports 360, 362, 364, 366 may accept an associated plurality of communication links for communication compatible with FC, SAS, S-ATA, and Ethernet protocols respectively from various initiator devices. Another plurality of ports 370, 372, 374, 376, 378 may accept an associated plurality of communication links for communication compatible with FC, SAS, S-ATA, Ethernet, and Parallel SCSI protocols respectively from various target devices. Routing circuitry 361, 371 may route data and/or commands from the various ports to the processing circuitry 302.

Protocol conversion circuitry 304 may include a variety of circuitry to convert a variety of communication protocols to another. Such protocol conversion circuitry 306 may include, but is not limited to, FC to SAS circuitry 310, FC to S-ATA circuitry 312, FC to Ethernet circuitry 314, SAS to FC circuitry 316, SAS to S-ATA circuitry 318, SAS to Ethernet circuitry 320, S-ATA to FC circuitry 322, S-ATA to SAS circuitry 324, S-ATA to Ethernet circuitry 326, Ethernet to FC circuitry 328, Ethernet to SAS circuitry 330, Ethernet to S-ATA circuitry 332 and SAS to Parallel SCSI circuitry 334.

Advantageously, the appropriate protocol conversion circuitry may be accessible by the processing circuitry 302 to perform an appropriate conversion as necessary. For example, primitive commands of one protocol may be converted into similar primitive commands of another protocol as appropriate by various mapping techniques. As used herein, a “primitive” may be defined as a group of one or more symbols, for example, representing control data to facilitate control of the transfer of information and/or to provide real time status information. For example, primitives defining frame boundaries of a received frame compatible with a first communication protocol may be mapped into associated frame boundary primitives compatible with a second communication protocol. Protocol conversion via such mapping may be implemented using store and forward or cut-through type methods.

For a store and forward type method, memory 306, in one instance, may be utilized by the processing circuitry 302 to store payload of one or more frames. For example, as a frame compliant with a first communication protocol is received, the payload of that frame may be stored in memory 306 as directed by the processing circuitry 302. Meanwhile, the processing circuitry 302 may access the appropriate protocol conversion circuitry. Primitives of one communication protocol may be converted to comparable primitives of another protocol if both communication protocols have similar primitive operations. The processing circuitry 302 may then access the stored payload from memory 306 and construct a new frame compliant with the new protocol and output such frame to the appropriate device.

In cut through methods, frames may not be stored but rather be cut-through the multi-protocol bridge with appropriate mapping. The protocol conversion circuitry 304 may also include upper layer protocol (ULP) mapping conversions to facilitate communication among a plurality of devices. For instance, the Fibre Channel over Transmission Control Protocol/Internet Protocol (TCP/IP) (FCIP) mapping protocol may be utilized. The FCIP protocol may comply or be compatible with the protocol described in “Fibre Channel Over TCP/IP (FCIP” Internet Draft, draft-itef-fcovertcpip-12.txt”, published August, 2002 by the Internet Engineering Task Force (IETF) and/or later published versions of the same. The FCIP protocol enables transmission of FC data over IP networks by encapsulation of the FC data.

Another ULP mapping conversion may include the Internet Fibre Channel Protocol (iFCP). The iFCP protocol may comply or be compatible with the protocol described in “iFCP—A Protocol for Internet Fibre Channel Storage Networking. Internet Draft, draft-itef-ips-ifcp-14.txt” published December, 2002 by the ITEF and/or later published versions of the same.

Yet another ULP mapping conversion may include internet Small Computer System Interface (iSCSI). The iSCSI protocol may comply or be compatible with the protocol described in “IP Storage Working Group, Internet Draft, draft-itef-ips-iscsi-20.txt”, published Jan. 13, 2003 by the IETF and/or later published versions of the same. The iSCSI protocol may allow SCSI codes to be generated from user request which may then be encapsulated for transmission over IP networks.

The multi-protocol bridge 101a may be utilized in a wide variety of applications. In one application, the multi-protocol bridge may be used as part of a RAID. The multi-protocol bridge may be included in the RAID to receive various inputs compliant with a variety of communication protocols from associated communication links. In this way, the multi-protocol bridge would enable the RAID to effectively communicate with a variety of initiator devices using any variety of communication protocols. When used in a RAID, a host of other value added applications 308 may also be equipped in the bridge. This may include, but are not limited to, virtualization, encryption and decryption functions, compression and decompression functions, etc.

The SAS to Parallel SCSI circuitry 334 of the multi-protocol bridge 101a enables a SAS device to effectively communicate with a Parallel SCSI device. For instance, a SAS initiator device, e.g., device 104, may be able to exchange data and/or commands with Parallel SCSI devices, e.g., devices 122, 124, 126, via the multi-protocol bridge 101 since the multi-protocol bridge 101a may utilize the SAS to Parallel SCSI circuitry 334 to convert information compatible with the SAS protocol to the Parallel SCSI protocol and vice versa. The SAS to Parallel SCSI circuitry 334 may be utilized in the multi-protocol bridge 101a or may be utilized in any other variety of devices such as intermediate devices including an expander such as a SAS expander.

The SAS to Parallel SCSI circuitry 334 may enable bidirectional communication between Parallel SCSI devices 122, 124, 126 and a SAS device, e.g., initiator 104, by presenting each Parallel SCSI device 122, 124, 126 having a particular target address on the Parallel SCSI bus 121 as a Serial Small Computer System Interface Protocol (SSP) device to the initiator device 104. In other words, the multi-protocol bridge 101a may present the Parallel SCSI devices 122, 124, 126 to any SAS device as if it were a SAS device. Although description is made herein to parallel SCSI to SAS/SSP conversions, Parallel SCSI to SAS/Serial Advanced Technology (ATA) tunneled Protocol (STP), and Parallel SCSI to SAS/Serial Management Protocol (SMP) conversions may also be made by the SAS to Parallel SCSI circuitry 334.

In one embodiment, the SAS to Parallel SCSI circuitry 334 may present each particular fixed target address on the Parallel SCSI bus 121 as a separate phy, e.g., a virtual phy. This is because Parallel SCSI is based on a bus standard that has fixed target addresses independent of the actual attached Parallel SCSI devices. A “phy” may be defined as an object and/or circuitry used to interface to one or more devices. The phy may comprise a physical phy containing transceiver circuitry to interface to the applicable communication link. The phy may alternately and/or additionally comprise a virtual phy to interface to another virtual phy or to a physical phy. Each phy may have a unique identifier.

Discovery of any Parallel SCSI devices, e.g., devices 122, 124, 126, may occur when the multi-protocol bridge 101a is reset or when power is applied. At this point in time, the multi-protocol bridge 101a may start a parallel bus scan process to discover what devices are coupled to the parallel bus 121. A parallel bus scan may require as much as 250 milliseconds (ms)/target address to determine if a target is actually present. In SAS, however, the initial IDENTIFY sequence may start within 1 ms of the Phy reset sequence taking place.

Therefore, the multi-protocol bridge 101a may not wait to complete the parallel bus scan before replying to a discover command from a SAS initiator device. Rather, it may transmit a BROADCAST (CHANGE) primitive if any Parallel SCSI device is found after the parallel bus scan is performed. Each device found on the Parallel SCSI bus 121 may be treated as an SSP device directly attached to the multi-protocol bridge 101a. Any time a Parallel SCSI device is newly discovered, a BROADCAST (CHANGE) primitive may be sent back to SAS devices to alert all SAS devices of the newly discovered device.

For SAS address assignment purposes, each virtual Phy of the multi-protocol bridge 101a associated with a Parallel SCSI device 122, 124, 126 may be used as the SAS address of the SAS port built from the Parallel SCSI target ID. Each port may also be a narrow port having one virtual Phy.

Parallel SCSI generally does not support a connection over which multiple commands and related data may be sent. Hence, the multi-protocol bridge 101a may utilize a SAS initiator's request for a connection to a Parallel SCSI device 122, 124, 124 as a signal to start or queue parallel bus arbitrations. For instance, upon delivery of an OPEN request from a SAS initiator, e.g., initiator 104, the multi-protocol bridge 101a may determine if it or a Parallel SCSI device has already arbitrated for ownership of the parallel bus 121. If the parallel bus 121 is not in use, the multi-protocol bridge 101a may respond with an OPEN_ACCEPT primitive to the SAS initiator device. The communication path, e.g., path 132, from the SAS initiator device to the multi-protocol bridge 101a may then be available for information unit transfer. The multi-protocol bridge 101a may then simultaneously start to arbitrate for ownership of the parallel bus 121.

If the parallel bus 121 is currently owned, the multi-protocol bridge 101a may apply a heuristic algorithm to decide how to respond to a request from a SAS initiator device to communicate with a Parallel SCSI device. An OPEN_ACCEPT primitive may be sent back to the SAS initiator device during a “speculatively accepted” condition. This speculatively accepted condition may occur if the number of queued requests for bus arbitrations is either low in number or the queued operations involve little data transfer and there is available space in memory 306 and/or a receive buffer to accept data such an SSP command frame.

Alternatively, the multi-protocol bridge 101a may respond to the SAS initiator device with an ARBITRATION IN PROGRESS (AIP) primitive if the number of queued requests is not low in number or the queued operations involve greater amounts of data. When the AIP primitive is transmitted back to the SAS initiator device, this may then allow a parallel bus operation that is already in progress to complete and it may then allow previously queued parallel bus operations to arbitrate for the parallel bus 121. The pending connection request may be recorded so that when the parallel bus 121 is relinquished, arbitration for bus ownership would start on behalf of all pending requests including the previously stored request. Once the previously executing operation has completed, the highest priority pending connection request may be ascertained from the queue and parallel bus arbitration starts again. Once arbitration completes and the pending operation request gains control, an OPEN_ACCEPT may be sent back to the SAS initiator. This heuristic algorithm may be applied in turn to each of the next highest priority pending requests in the queue to check if it should be moved to the “speculatively accepted” state.

The heuristic part of the algorithm may track “the speculatively accepted” connections that are broken due to timeout conditions from a given SAS initiator. These connection breaks may then be used a “high water” mark against the number of outstanding operations, outstanding data transfer requests, and outstanding parallel bus arbitration requests as statistics to decide if a given request is a candidate for “speculative acceptance.”

If a connection request from a SAS initiator device has been accepted and there is space in memory 306 and/or a receive buffer to accept a command frame, a receive ready RRDY primitive may be sent to the SAS initiator device by the multi-protocol bridge 101a in order to start the command execution process.

If the parallel bus 121 is owned by the multi-protocol bridge 101a, the command data from a SAS initiator device may be sent to a Parallel SCSI target device 122, 124, 126 by the multi-protocol bridge 101a. For each command frame delivered to the multi-protocol bridge from the SAS initiator device, the total amount of data that may be transmitted to (write operations) or received from (read operations) the Parallel SCSI device may be determined.

During write operations, if the amount of available space in memory 306 and/or a receive buffer is less than the amount of data to be written, a transfer ready type frame indicating the amount of available space may be sent to the SAS initiator. The SAS initiator may then send an amount of data which does not exceed the indicated amount of available space. For example, a receive ready type primitive, e.g., RRDY, may be sent to the SAS initiator to match the indicated amount of available space.

During read operations, the multi-protocol bridge 101a may close connection to the SAS initiator during the execution of a read command by a Parallel SCSI device. Once the read command is sent to the Parallel SCSI device, the parallel bus 121 may be freed. The multi-protocol bridge 101a may maintain at least one frame worth of space available in memory 306 and/or a receive buffer for any pending read operation.

When the Parallel SCSI device arbitrates for control of the parallel bus 121 in order to provide read data, the current connection state may be checked by the bridge expander. If there is no connection open to the SAS initiator and a connection request is sent, the available space in the multi-protocol bridge may be used to receive read data from the Parallel SCSI target device. If the space available to the multi-protocol bridge is exhausted before all the read data is received, the multi-protocol bridge 101a may request a DISCONNECT from the parallel bus.

When the Parallel SCSI protocol supported by the Parallel SCSI target device allows, an “auto request sense” may be enabled. If the Parallel SCSI device does not support this feature, the status field of executed commands may be inspected for pending check conditions. If a check condition status is seen, the multi-protocol bridge may generate a parallel SCSI request sense command to retrieve the end devices' sense data. The sense data may then be returned in the response frame to the SAS initiator.

A variety of SAS primitives for task management functions such as ABORT_TASK, ABORT_TASK_SET, CLEAR_ACA, CLEAR_TASK_SET, LOGICAL_UNIT_RESET, and QUERY_TASK may all map to the Parallel SCSI equivalent operation.

A variety of SCSI commands that control SAS SSP features may be intercepted and their operation may be simulated. In one instance, for the “disconnect-reconnect mode page” the “first burst” field may be set to zero to indicate that it will not be supported. For the NOTIFY (ENABLE_SPINUP) primitive, after an initial power up of a Parallel SCSI (detected by sense data that indicates a power-on condition), the multi-protocol bridge 101a may not pass along START UNIT (power condition ACTIVE) commands to the Parallel SCSI device until a NOTIFY (ENABLE_SPINUP) primitive is received. There may be two situations when this occurs. First, if the IMMED bit is set in the START UNIT command, the command may be completed back to the SAS initiator by the multi-protocol bridge 101a. Upon reception of the NOTIFY (ENABLE_SPINUP) primitive, the multi-protocol bridge 101a may generate a START UNIT (IMMED clear) command and sent it to the Parallel SCSI target device. Second, if the IMMED bit is clear in the START UNIT command, the multi-protocol device 101a may not complete the command back to the SAS initiator. Instead, the multi-protocol bridge may wait for reception of the NOTIFY (ENABLE_SPINUP) primitive, send the command to the Parallel SCSI device, and complete the command in the normal way.

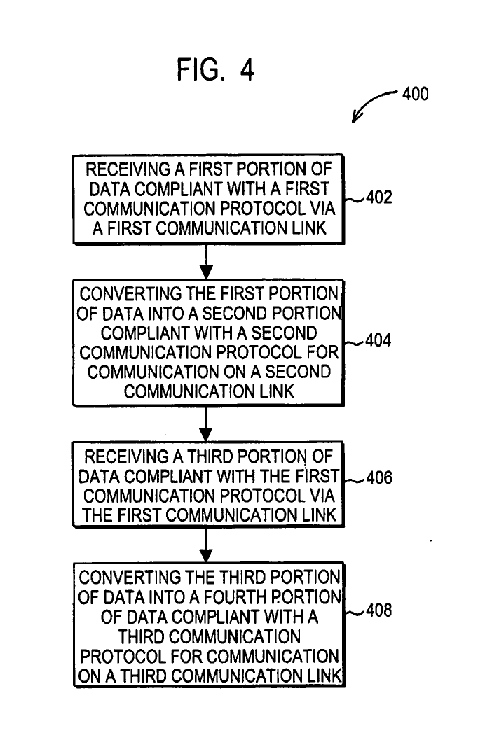

FIG. 4 is a flow chart of exemplary operations 400 consistent with an embodiment. Operation 402 may include receiving a first portion of data compliant with a first communication protocol via a first communication link. Operation 404 may include converting the first portion of data into a second portion of data compliant with a second communication protocol for communication on a second communication link. Operation 406 may include receiving a third portion of data compliant with the first communication protocol via the first communication link. Finally, operation 408 may include converting the third portion of data into a fourth portion of data compliant with a third communication protocol for communication on a third communication link.

It will be appreciated that the functionality described for all the embodiments described herein, may be implemented using hardware, firmware, software, or a combination thereof. If implemented in software, a machine such as a processing element, e.g., a processing circuitry 302, host processor 212, and one or more machine readable storage media may be utilized. One exemplary processing element may be a processor from the Pentium® family of processors made by the Assignee of this application, or the family of processors made by Motorola. Machine-readable media include any media capable of storing instructions adapted to be executed by a machine. Some examples of such media include, but are not limited to, read-only memory (ROM), RAM, programmable ROM (PROM), erasable programmable ROM (EPROM), electronically erasable programmable ROM (EEPROM), DRAM, magnetic disk (e.g. floppy disk and hard drive), optical disk (e.g. CD-ROM), and any other device that can store information. Further, the processing element and machine-readable storage medium may be part of a larger system that may contain various combinations of machine-readable storage devices, which through various input/output (I/O) controllers, may be accessible by the processing element and which may be capable of storing a combination of computer program instructions and data.

Thus, in summary, one embodiment may comprise a method. The method may comprise receiving a first portion of data compliant with a first communication protocol via a first communication link, converting the first portion of data into a second portion of data compliant with a second communication protocol for communication on a second communication link, receiving a third portion of data compliant with the first communication protocol via the first communication link; and converting the third portion of data into a fourth portion of data compliant with a third communication protocol for communication on a third communication link.

In summary, another embodiment may comprise an apparatus. The apparatus may comprise a plurality of ports capable of being coupled to a plurality of devices via an associated plurality of communication links. The apparatus may further comprise circuitry capable of receiving information from a first communication link compliant with a first communication protocol and converting the information for communication on a second communication link compliant with a second communication protocol. The circuitry may also be capable of receiving the information from the first communication link compliant with the first communication protocol and converting the information for communication on a third communication link compliant with a third communication protocol.

Advantageously, an apparatus capable of making multiple protocol conversions is provided. The apparatus can enable a device that communicates information compatible with one communication protocol to effectively communicate with two other devices that communicate information using two other communication protocols.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. An apparatus comprising:
a plurality of ports capable of being coupled to a plurality of devices via an associated plurality of communication links; and
circuitry capable of receiving information from a first communication link compliant with a first communication protocol and converting said information for communication on a second communication link compliant with a second communication protocol, said circuitry also capable of receiving said information from said first communication link compliant with said first communication protocol and converting said information for communication on a third communication link compliant with a third communication protocol.

2. The apparatus of claim 1, wherein said first communication protocol comprises a Serial Attached Small Computer Systems Interface (SAS) protocol and said second communication protocol comprises a Fibre Channel (FC) protocol.

3. The apparatus of claim 2, wherein said third communication protocol comprises an Ethernet protocol.

4. The apparatus of claim 1, wherein said first communication protocol comprises a Serial Attached Small Computer Systems Interface (SAS) protocol and said second communication protocol comprises a Parallel Small Computer System Interface (Parallel SCSI) protocol.

5. The apparatus of claim 4, wherein said circuitry presents each external device coupled to a Parallel bus for communication compatible with said Parallel SCSI protocol as a Serial Small Computer System Interface Protocol (SSP) device to at least one device compatible with said SAS protocol.

6. A system comprising:
at least one initiator device;
a first target device;
a second target device; and
a bridge comprising a port coupled to said at least one initiator device via a first communication link, a port coupled to said first target device via a second communication link, a port coupled to said second target device via a third communication link, and circuitry capable of receiving information from said first communication link compliant with a first communication protocol and converting said information for communication on said second communication link compliant with a second communication protocol to facilitate communication between said at least one initiator device and said first target device, said circuitry also capable of receiving said information from said first communication link compliant with said first communication protocol and converting said information for communication on said third communication link compliant with a third communication protocol to facilitate communication between said at least one initiator device and said second target device.

7. The system of claim 6, wherein said at least one initiator device comprises a circuit card and a bus, said circuit card capable of being coupled to said bus, said circuit card capable of communicating said information via said first communication link compliant with said first communication protocol to said bridge.

8. The system of claim 6, wherein said first communication protocol comprises a Serial Attached Small Computer Systems Interface (SAS) protocol and said second communication protocol comprises a Fibre Channel (FC) protocol.

9. The system of claim 8, wherein said third communication protocol comprises an Ethernet protocol.

10. The system of claim 6, wherein said first communication protocol comprises a Serial Attached Small Computer Systems Interface (SAS) protocol and said second communication protocol comprises a Parallel Small Computer System Interface (Parallel SCSI) protocol.

11. The system of claim 10, wherein said circuitry presents said first target device as a Serial Small Computer System Interface Protocol (SSP) device to said at least one initiator.

12. A method comprising:
receiving a first portion of data compliant with a first communication protocol via a first communication link;
converting said first portion of data into a second portion of data compliant with a second communication protocol for communication on a second communication link;
receiving a third portion of data compliant with said first communication protocol via said first communication link; and
converting said third portion of data into a fourth portion of data compliant with a third communication protocol for communication on a third communication link.

13. The method of claim 12, wherein said first communication protocol comprises a Serial Attached Small Computer Systems Interface (SAS) protocol and said second communication protocol comprises a Fibre Channel (FC) protocol.

14. The method of claim 13, wherein said third communication protocol comprises an Ethernet protocol.

15. The method of claim 12, wherein said first communication protocol comprises a Serial Attached Small Computer Systems Interface (SAS) protocol and said second communication protocol comprises a Parallel Small Computer System Interface (Parallel SCSI) protocol.

16. The method of claim 15, further comprising presenting each external device coupled to a Parallel bus for communication compatible with said Parallel SCSI protocol as a Serial Small Computer System Interface Protocol (SSP) device.

17. An article comprising:
a machine readable medium having stored thereon instructions that when executed by a machine result in the machine performing operations comprising:
receiving a first portion of data compliant with a first communication protocol via a first communication link;
converting said first portion of data into a second portion of data compliant with a second communication protocol for communication on a second communication link;
receiving a third portion of data compliant with said first communication protocol via said first communication link; and
converting said third portion of data into a fourth portion of data compliant with a third communication protocol for communication on a third communication link.

18. The article of claim 17, wherein said first communication protocol comprises a Serial Attached-Small Computer Systems Interface (SAS) protocol and said second communication protocol comprises a Fibre Channel (FC) protocol.

19. The article of claim 18, wherein said third communication protocol comprises an Ethernet protocol.

20. The article of claim 17, wherein said first communication protocol comprises a Serial Attached Small Computer Systems Interface (SAS) protocol and said second communication protocol comprises a Parallel Small Computer System Interface (Parallel SCSI) protocol.

21. The article of claim 20, wherein said operations further comprise presenting each external device coupled to a Parallel bus for communication compatible with said Parallel SCSI protocol as a Serial Small Computer System Interface Protocol (SSP) device.
